(19) United States
(12) Patent Application Publication
(10) Pub. No.: US 2008/0232255 A1
(43) Pub. Date: Sep. 25, 2008

(54) TRANSMISSION APPARATUS, MAINTENANCE FRAME PROCESSING METHOD, AND RECORDING MEDIUM HAVING A TRANSMISSION PROGRAM

(75) Inventors: Toshinobu Tsunematsu, Fukuoka (JP); Shinichi Shiwachi, Fukuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/048,856

(22) Filed: Mar. 14, 2008

(30) Foreign Application Priority Data
Mar. 19, 2007 (JP) 2007-071656

(51) Int. Cl. G06F 11/00

(52) U.S. Cl. 370/236.2

(57) ABSTRACT

The disclosed apparatus and method include transmitting and receiving frame(s) to/from another transmission apparatus, storing header information of user frames that are currently being transmitted to the other transmission apparatus, detecting whether the maintenance frame was received, splitting user frames and interrupting the transmission processing of the user frames, adding to subsequent user frames combination information, performing a transmission processing on response maintenance frames, resuming transmission processing of the subsequent user frames, and adding combination information and header information.

### CROSS-REFERENCE TO RELATED APPLICATIONS

This application is related to and claims priority to Japanese patent application no. 2007-71656 filed on Mar. 19, 2007, in the Japan Patent Office, and incorporated by reference herein.

### BACKGROUND

1. Field

The present invention relates to a transmission apparatus and method which transmits and receives user frames generated by a user apparatus or maintenance frames used for network maintenance to/from another transmission apparatus, which forms a network along with the transmission apparatus, a method of processing maintenance frames, and the transmission program.

With development of the Ethernet® (registered trademark), technical standard relating to maintenance functions and administration functions of an Ethernet network is set forth. This technical standard is called Ethernet OAM (Operation Administration Management). With the Ethernet OAM, various maintenance functions and administration functions are realized by transmitting and receiving special OAM frames to/from transmission apparatuses such as L2SW (Layer 2 Switch) apparatuses. In a Japanese Unexamined Patent Application (e.g. Japanese Unexamined Patent Application Publication No. 2002-368711), a technology whereby OAM frames are used to detect an occurrence of anomalies in low-speed reception lines and removal of reception modules is discussed.

Measuring a delay time of predetermined pathways in a network is one of the maintenance functions and administration functions that are realized by Ethernet OAM. In a Japanese Unexamined Patent Application (e.g. Japanese Unexamined Patent Application Publication No. 2004-289716), first measuring a one-way delay time, which is the delay time to a remote apparatus, to the remote apparatus in advance is a technology that uses such delay time measurement. Next, data threshold that can be stored in a buffer is determined according to the measured delay time. A technology that thereby prevents buffer overflows is discussed.

There is a technology which measures a round-trip delay time. According to this technology, a predetermined transmission apparatus “A” sends OAM frames providing a transmission time to a pathway that is the measurement object. Then, the transmission apparatus “A” receives OAM frames that were looped back by a transmission apparatus “B” that received the OAM frames, and measures the round-trip delay time which is a difference between a reception time and a transmission time.

### SUMMARY

The disclosed apparatus and method include transmitting and receiving to/from another transmission apparatus, which forms a network along with a transmission apparatus, user frames generated by a user apparatus and maintenance frames which are used for the maintenance of the network, storing header information of user frames that are currently being transmitted to the other transmission apparatus, and detecting whether a maintenance frame was received during the transmission processing of user frames to be transmitted to the other transmission apparatus.

The disclosed apparatus includes an interruption unit splitting user frames during the transmission processing and interrupting the transmission processing of the user frames when a detection indicates that a maintenance frame is received during transmission processing of user frames, a transmission processing control unit adding to subsequent user frames combination information which is used for combining with the user frames transmitted during interruption(s) by the interruption unit, and a response maintenance frame transmission processing unit performing transmission processing on response maintenance frames which are responses to the maintenance frames when the transmission processing of user frames is interrupted by the interruption unit.

The disclosed method and system includes resuming transmission processing of subsequent user frames which were interrupted when transmission processing was performed on the response maintenance frames and adding combination information and header information for combining pre-interruption user frames to the user frames which are transmitted when transmission processing is resumed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1A through 1F are overviews and feature(s) of a transmission apparatus.

FIG. 2 is a block diagram illustrating a configuration of a transmission apparatus.

FIG. 3 is a view illustrating an example of information stored by a header information storage part.

FIG. 4 is a block diagram illustrating a configuration of a transmission apparatus.

FIG. 5 is a flow chart illustrating a flow of process(es) performed by a transmission apparatus.

FIG. 6 is a flow chart illustrating a flow of the process(es) performed by a transmission apparatus.

FIG. 7 is a figure illustrating a computer executing a transmission program.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

A transmission apparatus, a transmission program a computer-readable medium embodying a program, and a method of processing maintenance frames are explained referring to the following drawings. Hereinafter, terminology used in an embodiment, an overview and feature(s) of a transmission apparatus relating to an embodiment, a configuration and processing flow of the transmission apparatus relating to an embodiment, and effect(s) of the embodiment are explained in order. Then, another embodiment included in the present invention is explained.

Explanation of Terminology

First, terminology used in an embodiment is explained. The term “transmission apparatus” used in the following embodiment refers to a relay apparatus which relays data between one transmission apparatus and another transmission apparatus according to a predetermined technical standard (e.g. Ethernet® (registered trademark)). The transmission apparatus forms a network along with the other transmission apparatus and relays user frames to/from the other transmission apparatus.

Also, the term “user frame” refers to a unit for data which is handled according to a predetermined technical standard (e.g. Ethernet® (registered trademark)). The user frame comprises, at a minimum, a header which includes a transmission source address and a destination address, and data.

Also, the term “OAM frame” refers to data which is used to realize maintenance function(s) and administration function(s) of a network (e.g. an Ethernet® (registered trademark) network). Especially in the present embodiment, an “OAM frame” is used to measure a round-trip delay time of a predetermined path in a network. The round-trip delay time can be measured from a transmission time at which the transmission apparatus transmitted the OAM frame, and a reception time at which the OAM frame was received after being returned from the other transmission apparatus.

Overview and features of a transmission apparatus relating to an embodiment

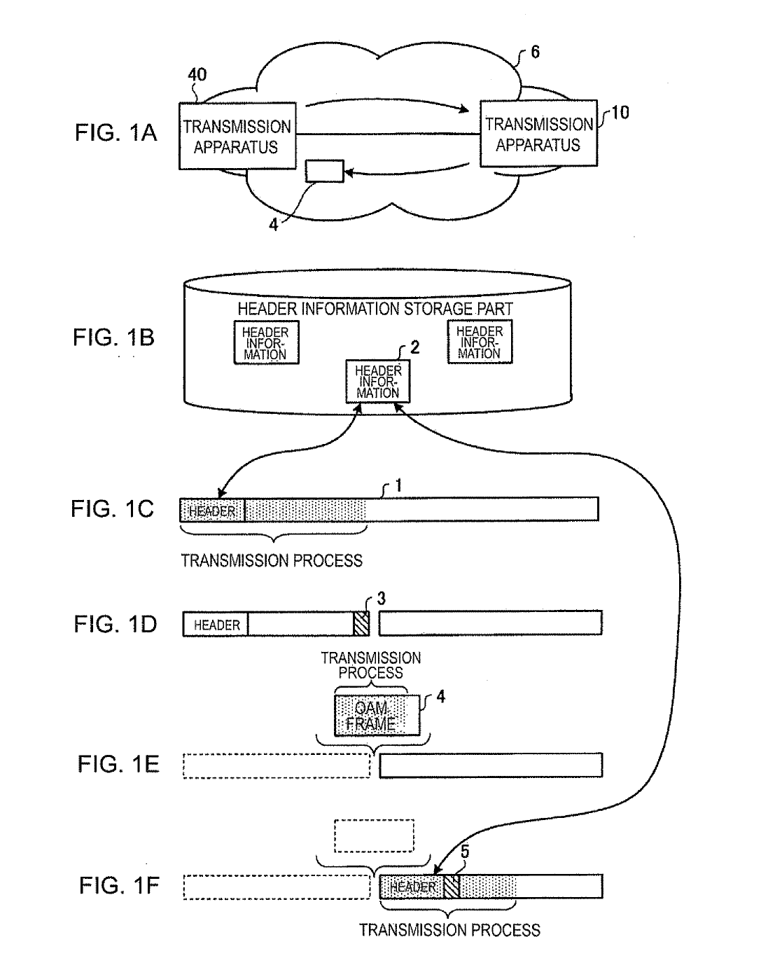

First, FIG. 1 will be used herein to explain an overview and feature(s) of a transmission apparatus. FIG. 1 is a view which explains an overview and feature(s) of a transmission apparatus relating to an embodiment.

The transmission apparatus relating to this embodiment is configured to transmit and receive to/from another transmission apparatus with which a network is formed, user frames generated by a user apparatus and OAM frames used to maintain the network. This transmission apparatus is implemented to make precise measurement(s) of around-trip delay time possible. As shown in FIG. 1A, there are two transmission apparatuses in a network 6. One of these apparatuses is transmission apparatus 40 which measures a round-trip delay time. The other apparatus is a transmission apparatus 10 which returns an OAM frame 4 which was transmitted by the transmission apparatus 40. Both apparatuses have similar functions.

The main features of the transmission apparatuses are explained below. The transmission apparatus 10 stores header information of a user frame that is currently being transmitted to the other transmission apparatus. To explain in more detail, as shown in FIG. 1B and FIG. 1C, the transmission apparatus 10 stores header information 2, which is a copy of a header of a user frame 1 which is currently being transmitted.

Then, the transmission apparatus 1 0 detects whether or not an OAM frame was received during a transmission processing of a user frame to the other transmission apparatus. To explain in more detail, as shown in FIG. 1C, the transmission apparatus 10 detects any OAM frame(s) that were received during the transmission processing of the user frame 1. In FIG. 1, shaded portions of the user frame indicate what has been transmitted, thereby indicating that a transmission processing of subsequent data is continuing.

Then, the transmission apparatus 10, if it has detected that an OAM frame was received during the transmission processing of a user frame, controls transmission processing by splitting the user frame being transmitted and interrupting transmission processing of the user frame. After that, the transmission apparatus 10 adds on combination information for combining subsequent user frames with the user frames being transmitted during the interruption.

FIG. 1C and FIG. 1D are used to explain an example. If reception of an OAM frame was detected during the transmission processing of the user frame 1, the transmission apparatus 10 splits the user frame 1 into a transmitted portion and an untransmitted portion and interrupts the transmission processing to subsequent data. After that, the combination information 3 is added on to the transmitted portion.

Then, when the transmission processing of a user frame is interrupted, the transmission apparatus 10 performs transmission processing on a response OAM frame, which is a response to an OAM frame. FIG. 1E is used to explain an example. As shown in FIG. 1E, instead of transmitting subsequent data, the transmission apparatus 10 starts transmitting the OAM frame 4 (note, the dotted line in FIG. 1 expresses frames that have been completely transmitted).

Then, if a response OAM frame has been processed for transmission, the transmission apparatus 10 resumes transmission processing of the subsequent user frame that was interrupted. After that, the transmission apparatus 10 adds on combination information and the stored header information for combining a pre-interruption user frame with the user frame which is transmitted when the transmission processing is resumed.

FIG. 1F is used to explain an example. After transmission processing of the OAM frame 4 is complete, the transmission apparatus 10 resumes transmission processing to the subsequent data which follows the user frame 1 in addition to adding on header information 2 and combination information 5 that was stored during the transmission processing of the user frame 1.

Note, in FIG. 1F, during transmission processing of the subsequent data which follows the user frame 1, if another OAM frame is received, the transmission apparatus 10 performs a process similar to the process to have the transmission of multiple OAM frames break in during the transmission of a single user frame.

On the other hand, if the transmission apparatus 40 receives user frames which were split by the transmission apparatus 10, the transmission apparatus 40 uses combination information to combine the user frames with each other. FIG. 1D and FIG. 1F are used to explain an example. When the transmission apparatus 40 receives a user frame to which the combination information 3 has been added on and a user frame to which the combination information 5 has been added, the transmission apparatus 40 combines both frames together, restoring the frames to the original user frame 1.

Therefore, this transmission apparatus can measure a precise round-trip delay time according to the features described above. In other words, by interrupting the transmission processing of user frames and breaking in with a response OAM frame in transmission, an amount of time spent on processing user frames for transmission can be reduced. As a result, it is possible to measure a precise round-trip delay time. Also, it becomes possible to restore user frames that were split in order have OAM frames break in.

Note, a transmission apparatus is not limited to a relay apparatus in an Ethernet® (registered trademark) network. This transmission apparatus is sufficient when serving as a relay apparatus in a network wherein maintenance function and administration function is realized by exclusive data, and this transmission apparatus is not a router or like apparatus.

A case in which the transmission apparatus 10 and the transmission apparatus 40 are directly connected was explained above. However, the present apparatus is not limited to the above, and it is also permissible for another transmission apparatus to exist between the transmission apparatus 10 and the transmission apparatus 40.

Configuration of Transmission Apparatus 10

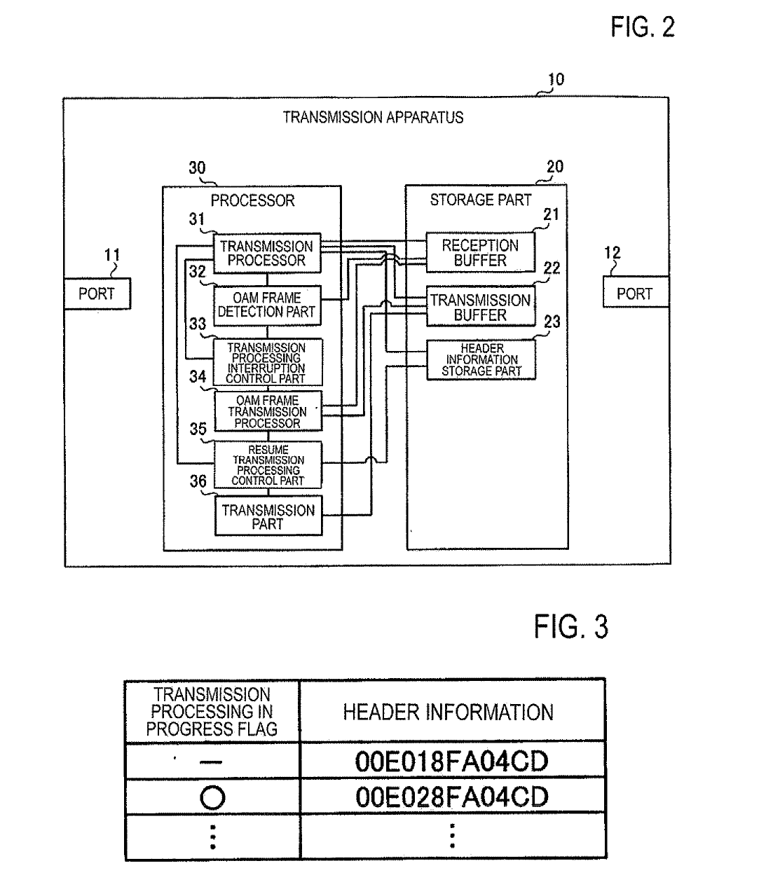

Next, FIG. 2 is used herein to explain a configuration of the transmission apparatus 10 shown in FIG. 1. Note, FIG. 2 is a block diagram showing the configuration of the transmission apparatus 10. Also, a configuration which supports a process wherein user frames are split and relayed and a process wherein OAM frames are responded to is explained hereinafter.

As shown in FIG. 2, the transmission apparatus 10 comprises ports 11 and 12 which serve as physical connection ports to/from which the frames are input or output, a storage part 20, and a processor 30. Note, the transmission apparatus 10 has two ports 11 and 12, but the disclosed transmission apparatus 10 is not limited to any particular number of port(s).

The storage part 20 stores data which is used in each process performed by the processor 30. The storage part 20 comprises a reception buffer 21, a transmission buffer 22, and a header information storage part 23. Note, the header information storage part 23 corresponds to the “header information storage means” described in the claims.

The reception buffer 21 stores user frames and OAM frames that were received. More specifically, the reception buffer 21 stores user frames and OAM frames that were input from ports 11 and/or 12. Also, the reception buffer 21 stores user frames and OAM frames until a transmission processing by a transmission processor 31 described hereinafter is completed.

The transmission buffer 22 stores user frames and OAM frames that were transmitted. More specifically, the transmission buffer 22 reads user frames and OAM frames using a transmission part 36 described hereinafter. Also, the transmission buffer 22 stores user frames and OAM frames until the frames are transmitted from ports 11 and/or 12.

The header information storage part 23 stores header information for user frames that are being transmitted to another transmission apparatus. More specifically, as shown in the FIG. 3, the header information storage part 23 correlates a copy of header information which is output from the transmission processor 31 to a transmission processing in a progress flag which indicates whether or not the user frame including the same header information is being transmitted, then stores a result thereof. As shown in FIG. 3, for example, the header information storage part 23 correlates the header information copy “00E028FA04CD” to the transmission processing in a progress flag “on state”, then stores a result thereof. Note, the header information storage part 23 can also store header information for all user frames that were received. In such cases, the header information storage part 23 stores at least the header information that is actually being transmitted.

The processor 30 controls the transmission apparatus 10 and executes various processes. More specifically, the processor 30 comprises the transmission processor 31, an OAM frame detection part 32, a transmission processing interruption control part 33, an OAM frame transmission processor 34, a transmission processing resume control part 35, and a transmission part 36. Note, the OAM frame detection part 32 corresponds to “maintenance frame detection means” described in the scope of the patent claims below. The transmission processing in progress control part 33 corresponds to “transmission processing interruption control means” described in the same scope of the patent claims below. The OAM frame transmission processor 34 corresponds to “response maintenance frame transmission processing means” described in the same scope of the patent claims below. The transmission processing resume control part 35 correspond to “transmission processing resume control means” described in the same scope of the patent claims below.

The transmission processor 31 performs a transmission processing pertaining to user frames or OAM frames. Specifically, the transmission processor 31 reads user frames or OAM frames from the reception buffer 21 and performs transmission processing while outputting the frames to the transmission buffer 22. At this time, the transmission processor 31 outputs the copy of the header information of the user frame to the information storage part 23. After that, only a flag which was correlated to the copy of the header information in the header information storage part 23 is needs to be set to an “on” state.

The OAM frame detection part 32 detects whether or not an OAM frame was received during a transmission processing of a user frame to the other transmission apparatus. More specifically, first the OAM frame detection part 32 monitors a processing operation(s) of the transmission processor 31 and the frame input to the reception buffer 21. Next, if an OAM frame is input to the reception buffer 21 when the transmission processor 31 is performing transmission processing on a user frame, a control signal which indicates a beginning of processing is output to the transmission processing interruption control part 33 described hereinafter.

If reception of a maintenance frame is detected during the transmission processing of a user frame, the transmission processing interruption control part 33 realizes control by splitting user frames currently being processed for transmission and interrupting the transmission processing of the user frame. In addition to the above processing, the transmission processing interruption control part 33 adds combination information for combining the user frame which is transmitted during the interruption with the subsequent user frame.

A specific flow is explained below. First, the transmission processing interruption control part 33 gets the control signal from the OAM frame detection part 32. Then, the transmission processing interruption control part 33 splits the user frame which the transmission processor 31 is actually performing transmission processing on into a portion for which a transmission processing has already been performed and a portion for which a transmission processing has not been performed. And then, the transmission processing interruption control part 33 controls the transmission processing part 31 and interrupts transmission processing of the subsequent data. After that, combination information (e.g. a number that is sequentially added on) for combining the portion for which transmission processing has already been performed with the subsequent user frame is added on. Also, after interrupting the transmission processing of the transmission processor 31, the transmission processing interruption control part 33 outputs to the OAM frame transmission processor 34 a control signal which indicates the beginning of processing. Note, if a number that is sequentially added is added on as combination information, the transmission processing interruption control part 33 determines a next number for the same operation starting from the same number as the transmission processing resume control part 35 described hereinafter.

If transmission processing of a user frame is interrupted, the OAM frame transmission processor 34 responds to the OAM frame. Specifically, first the OAM frame transmission processor 34 gets the control signal from the transmission processing interruption control part 33. Next, the OAM frame transmission processing part 34 reads the OAM frame from the reception buffer 21 and converts an address into the transmission apparatus 40's address, which is the transmission source, while outputting the OAM frame to the transmission buffer 22. Also, when transmission processing of the OAM frame is complete, the OQAM frame transmission processor 34 outputs the control signal which indicates the beginning of processing to the transmission processing resume control part 35 described hereinafter.

If transmission processing is performed on an OAM frame, the transmission processing resume control part 35 performs control so transmission processing of the subsequent user frame that was interrupted resumes. In addition, combination information and the header information for combining the pre-interruption user frame with the transmitted user frame when resuming the transmission processing is added on.

Specifically, after getting the control signal from the OAM frame transmission processor 34, the transmission processing resume control part 35 performs control so that transmission processing to the subsequent data which was interrupted by the transmission processor 31 resumes. In this case, the transmission processing resume control part 35 adds on to the subsequent data the combination information (e.g. a number that is sequentially added on) for combining with a user frame that transmission processing has been performed on before the transmission process was interrupted. After that, the header information which was correlated to a flag in an “on” state from the header information storage part 23 is read (see FIG. 3), then the header information is added on to the subsequent data. Note, if a number that is sequentially added on is added as combination information, the transmission processing resume control part 35 determines the next number for a same operation starting from the same number as the transmission processing interruption control part 33.

The transmission part 36 transmits user frames and OAM frames. Specifically, the transmission part 36 reads the user frame and OAM frame from the transmission buffer 22 then transmits the frames.

Configuration of the Transmission Apparatus 40

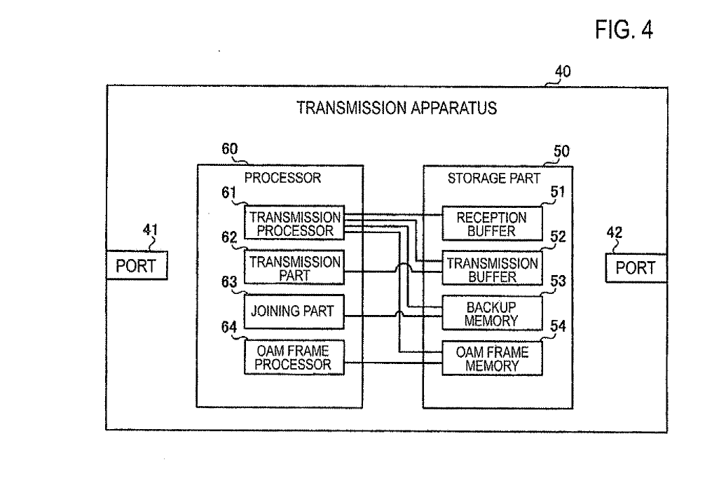

FIG. 4 is used to explain a configuration of the transmission apparatus 40. Note, FIG. 4 is a block diagram showing the configuration of the transmission apparatus 40. The configuration which supports a process of combining and relaying user frames and a process of sending OAM frames then receiving the returned OAM frames is described hereinafter.

As shown in FIG. 4, the transmission apparatus 40 comprises parts 41 and 42 which serve as physical connections ports to/from which the frames are input or output, a storage port 50, and a processor 60.

The storage part 50 stores data which is used in each process performed by the processor 60. The storage part 50 comprises a reception buffer 51, a transmission buffer 52, a backup memory 53, and an OAM frame memory 54. Note, function(s) of the reception buffer 51 and the transmission buffer 52, which are similar to the functions of the reception buffer 21 and the transmission buffer 22 in the transmission apparatus 10, will not be explained herein.

The backup memory 53 stores user frames that were split. Specifically, the backup memory 53 stores the user frames which were output from the transmission processor 61 described hereinafter.

The OAM frame memory 54 stores OAM frames. Specifically, the OAM frame memory 54 stores the OAM frames which were output from the transmission processor 61 described hereinafter.

The processor 60 controls the transmission apparatus 40 and executes various processes. The processor 60 comprises the transmission processor 61, a transmission part 62, a joining (combining) part 63, and an OAM frame processor 64. Note, the joining (combining) part 63 corresponds to “combining means” in the claims.

The transmission processor 61 performs transmission processing and reception processing in relation to user frames or OAM frames. Specifically, the transmission processor 61 reads from the reception buffer 51 user frames to which combination information was not added on. Next, while the transmission processor 61 is performing typical transmission processing, the transmission processor 61 stores the user frames in the transmission buffer 52. Also, when the transmission processor 61 reads user frames to which combination information was added on, the transmission processor 61 stores the user frames in the backup memory 53.

After the transmission processor 61 gets OAM frames from the OAM frame processor 64 described hereinafter, the transmission processor 61 performs transmission processing on the OAM frames. Then, the transmission processor 61 stores the OAM frames in the transmission buffer 52. Also, when the transmission processor 61 reads from the reception buffer 52 the OAM frames that were returned by the transmission apparatus 10, the transmission processor 61 stores the OAM frames in the OAM frame memory 54.

The transmission part 62 transmits user frames and OAM frames. Specifically, the transmission part 62 reads the user frame and OAM frame from the transmission buffer 52 and transmits the frame(s).

If the joining (combining) part 63 receives user frames which were split by another transmission apparatus, the joining (combining) part 63 combines the user frames together based on combination information (e.g. a number that is sequentially added on). Specifically, when the rear-most user frame which was split by the transmission processor 61 is stored in the backup memory 53, the joining (combining) part 63 restores the original user frame by reading from the backup memory 53 the user frames in which the common header information was split while deleting the combination information and combining the split user frames.

In addition to transmitting OAM frames, the OAM frame processor 64 receives a response thereto and calculates a round-trip delay time. Specifically, the transmission of OAM frames is explained hereinafter. The OAM frame processor 64 generates an OAM frame at each predetermined timing (e.g. regular interval). Then, the OAM frame processor outputs the OAM frame to the transmission processor 61. In other words, after the transmission processor 61 performs transmission processing, the OAM frame is output by the transmission part 62. Next, the reception of OAM frames is explained hereinafter. When the OAM frame is stored in the OAM frame memory 54 by the transmission processor 61, the OAM frame processor 64 reads the OAM frame and measures the round-trip delay time as a difference between the provided reception time and transmission time.

Processing by Transmission Apparatus 10

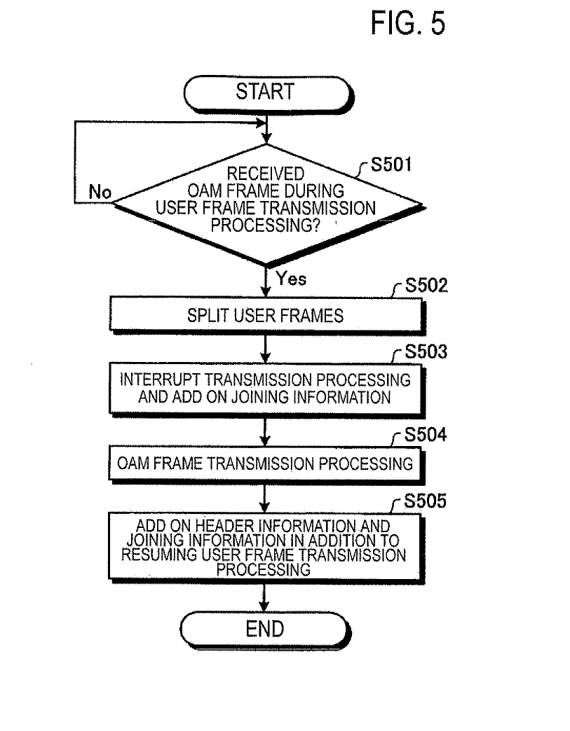

Next, FIG. 5 is used to explain a processing performed by the transmission apparatus 10. FIG. 5 is a flow chart showing a flow of a processing performed by the transmission apparatus 10.

As shown in FIG. 5, when an OAM frame is received while user frame transmission processing is in progress (operation S501 “Yes”), the transmission apparatus 10 splits the user frame which transmission processing is currently being performed on into a portion that transmission processing has already been performed on and a portion that transmission processing has not yet been performed on (operation S502). When a determination is made that the OAM frame is not received during user frame transmission processing is in process (operation S501 “No”), the process continues detecting for an OAM frame. Next, the transmission apparatus 10 interrupts transmission processing being performed on the user frames, adds joining (combination) information on to the portion which transmission processing has not yet been performed on (operation S503), then performs transmission processing on the OAM frame (operation S504).

Then, after performing transmission processing on the OAM frame, the transmission apparatus 10 resumes transmission processing on the portion of the user frame (S505) which transmission processing has not yet been performed on. In addition the transmission apparatus 10 adds on header information and the joining (combination) information (operation S505) and ends processing.

Processing by Transmission Apparatus 40

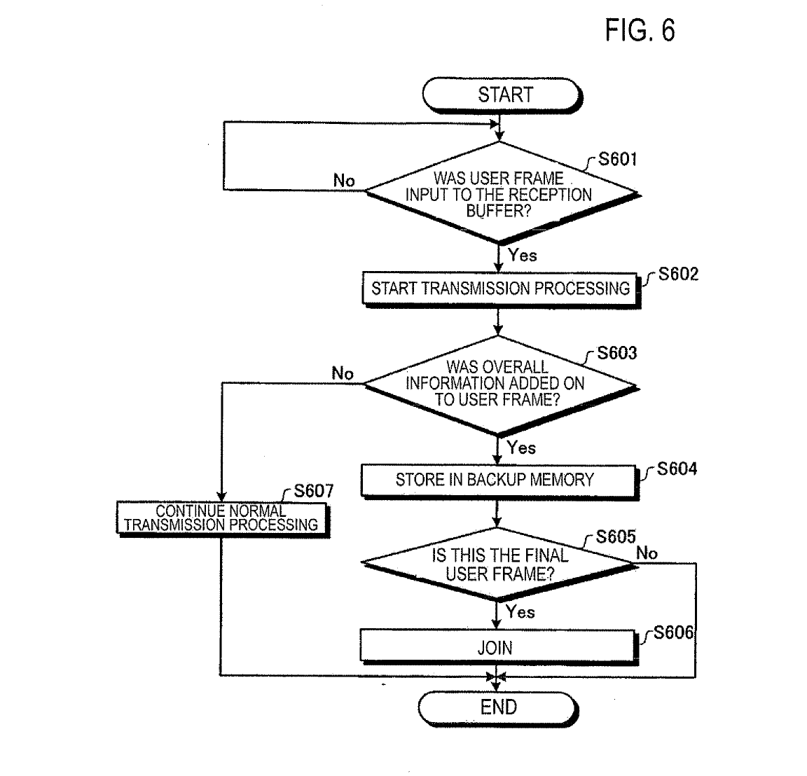

Next, FIG. 6 is used to explain a processing performed by the transmission apparatus 40. FIG. 6 is a flow chart showing a flow of a processing performed by the transmission apparatus 40.

As shown in FIG. 6, when a user frame is input to the reception buffer (operation S601 “Yes”), the transmission apparatus 40 starts transmission processing on the user frame (operation S602). When overall (combination) information has been added to the user frame (operation S603 “Yes”), the transmission apparatus 40 stores the user frame in the backup memory 53 (operation S604). When a final (rear-most user frame) of the user frames that were split is stored in the backup memory 53 (operation S605 “Yes”), the transmission apparatus 40 joins (combines) the user frames together based on the combination information added on to the user frames (operation S606). This is the end of processing. Note, if no overall (combination) information was added on to the user frame which transmission processing is currently being performed on (operation S603 “No”), the transmission apparatus 40 performs normal transmission processing (operation S607), then ends the processing.

As explained above in accordance with an embodiment header information of user frames which are currently being processed for transmission to another transmission apparatus is stored. Then, if reception of an OAM frame is detected while transmission processing of a user frame intended for another transmission apparatus is in progress, control is performed wherein the user frame for which transmission processing is currently being performed is split and transmission processing of the user frame is interrupted. In addition to the above control, combination information for combining with the user frame which is transmitted during the interruption is added on to the subsequent user frame. Also, if transmission processing of a user frame is interrupted, transmission processing of a response OAM frame, which is a response to an OAM frame, is performed. After transmission processing is performed on a response OAM frame, control wherein transmission processing of the subsequent user frame which was interrupted is resumed. In addition to this control, combination information for combining with a pre-interruption user frame and the stored header information is added on to the user frame which is transmitted when the transmission processing was resumed. Therefore, it is possible to measure a precise round-trip delay time. In other words, by interrupting a transmission processing of a user frame and transmitting a response OAM frame so it breaks in, it is possible to reduce an amount of time spent on the transmission processing of user frames and measure a precise round-trip delay time.

Also, according to an embodiment, if user frames which were split by another transmission apparatus are received, the user frames are combined with each other based on the combination information. In this way, it becomes possible to restore user frames that were split in order to have OAM frames break in.

An embodiment of the present apparatus has been explained above, but it is possible for the disclosed apparatus and method to implement a variety of modalities in addition to that in the embodiment described above. Next, different embodiments will be explained below in groups (1) through (4) as shown below.

(1) Configuration of Processing

In the embodiment discussed above, the configuration wherein the transmission apparatus 10 which measures the round-trip delay time supports a process of splitting user frames and the transmission apparatus 40 which returns the OAM frame 4 supports a process of combining split user frames was explained. However, the present apparatus is not limited to this configuration. One transmission apparatus can also be configured to support processing(s) of the transmission apparatus 10 and transmission apparatus 40.

(2) User Frames

User frames having a configuration which at a minimum included a header which contains a transmission source address and a destination address and data were explained. However, the disclosed apparatus and method are not limited to this configuration and can have any configuration which complies with a predetermined technical standard. When complying with the Ethernet® (registered trademark) standard for example, the disclosed apparatus can also be configured to handle MAC (Media Access Control) frames comprising a header, data, and FCS (Frame Check Sequence) as user frames. Note, when splitting MAC frames, adding an FCS to each split frame is preferable.

(3) System Configuration, etc.

Also, each constituent of each apparatus shown conceptualizes a function thereof and does not necessarily have to be configured as physically shown. In other words, specific configurations of distribution or integration are not limited to the modalities shown. For example, integrating the OAM frame detection part 32 and the transmission processing interruption control part 33 together is possible. Configuring so the apparatus, either partially or in its entirety, is functionally or physically distributed or integrated in any unit according to the load and status of use is possible. Furthermore, each processing function(operation) performed in each apparatus, either any part thereof or in its entirety, can also be realized by a CPU and a program which performs analysis in the CPU. Alternatively, the above can also be realized as hardware by wired logic. In addition, unless specified otherwise, any procedure, control process, and information including specific names, data, and parameters (e.g. the “on status” of the transmission processing in progress flag) either explained in writing above or shown in any figure above can be arbitrarily changed.

(4) Transmission Program

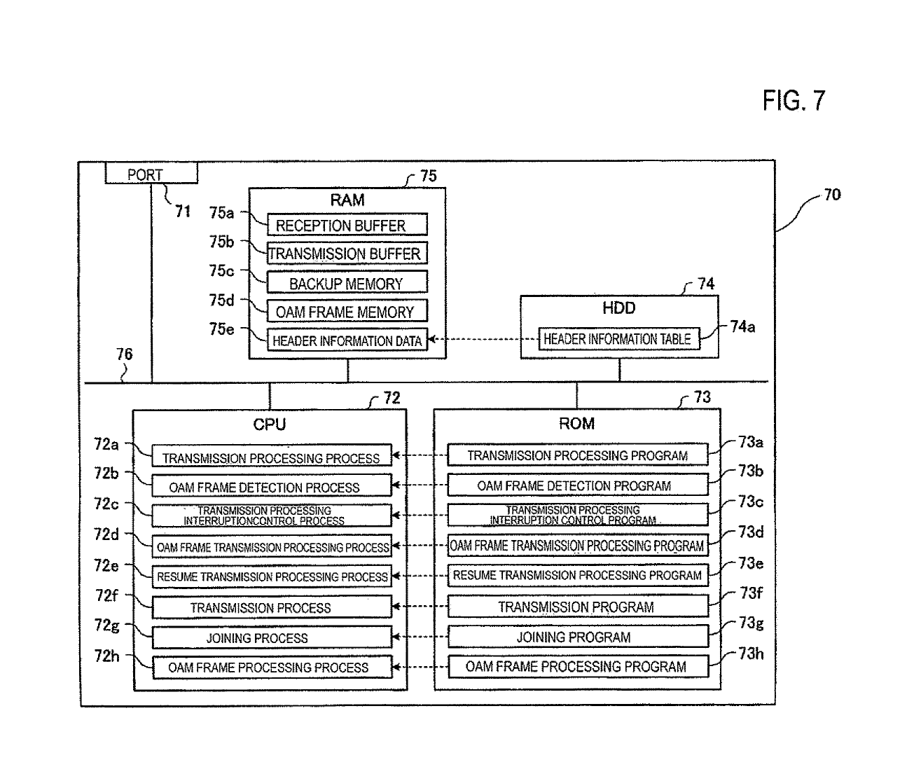

an Embodiment that was set forth above explained a case in which each process was realized by hardware logic. The present apparatus is not limited to such embodiment and can be realized by executing a prepared program on a computer. Hereinafter, an example of a computer which executes a transmission program causing the computer to execute similar function(s) to the transmission apparatuses indicated above is explained using FIG. 7. FIG. 7 is a figure showing a computer executing a transmission program.

As shown in FIG. 7, a computer 70, which functions as a transmission apparatus, is configured wherein a port 71, a CPU 72, a ROM memory 73, a hard disk drive 74, and a RAM memory 75 are connected by a bus 76 or other interface(s).

As shown in FIG. 7, a transmission processing program 73a, an OAM frame detection program 73b, a transmission processing interruption control program 73c, an OAM frame transmission processing program 73d, a resume transmission processing program 73e, a transmission program 73f, a joining (combination) program 73g, and an OAM frame processing program 73h are stored in ROM memory 73 in advance. The above programs correspond to a transmission program which exhibits similar function(s) to that of the transmission apparatus 10 and transmission apparatus 40 indicated above. Note, similar to each constituent of the transmission apparatus 10 and the transmission apparatus 40 shown in FIG. 2 and FIG. 4, these programs 73a through 73h can be integrated or distributed as necessary.

The CPU 72 reads programs 73a through 73h from ROM memory 73 then executes the programs. In this way, programs 73a through 73h function as a transmission processing process 72a, an OAM frame detection process 72b, a transmission processing interruption control process 72c, an OAM frame transmission processing process 72d, a resume transmission processing process 72e, a transmission process 72f, a joining (combination) process 72g, and an OAM frame processing process 72h as shown in FIG. 7. Note, processes 72a through 72h correspond to the transmission processor 31 (transmission processor 61), the OAM frame detection part 32, the transmission processing interruption control part 33, the OAM frame transmission processor 34, the transmission processing resume control part 35, and transmission part 36, the joining (combining) part 63, and the OAM frame processor 64 shown in FIG. 2 and FIG. 4.

Also, a header information table 74a is provided in the hard disk drive 74 as shown in FIG. 7. Note, the header information table 74a corresponds to the header information storage part 23 shown in FIG. 2. The CPU 72 reads the header information table 74a and stores the read content thereof in RAM memory 75. After that, the CPU 72 performs transmission processing based on header information data stored in RAM memory 75 in addition to data stored in a reception buffer 75a, a transmission buffer 75b, backup memory 75c, and OAM frame memory 75d.

Note, the programs 73a through 73h do not necessarily have to be stored in ROM memory 73 from the beginning. For example, storing each program in a portable physical media, a fixed physical media, or another computer (or server), having the computer 70 read then execute each program from the above media or computer, etc., is also acceptable. A portable physical media can be a flexible disk (FD), CD-ROM, MO disk, DVD disk, or IC card which is inserted into the computer 70. A fixed media can be a hard disk drive or other such media provided to the computer 70 internally or externally. Another computer can be a computer which can be connected to through a public line, the internet, LAN, or WAN.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A transmission apparatus comprising:
a transmission-reception unit transmitting and receiving, user frames generated by a user apparatus and maintenance frames used for maintenance of a network, to/from another transmission apparatus in the network;
a header information storage unit storing header information of user frames that are currently being transmitted to the other transmission apparatus;
a maintenance frame detection unit detecting whether a maintenance frame is received during a transmission processing of the user frames to the other transmission apparatus;
an interruption unit splitting the user frames during the transmission processing and interrupting the transmission processing of the user frames when said detecting indicates that the maintenance frame is received during the transmission processing of user frames;
a transmission processing control unit adding to subsequent user frames combination information which is used for combining with the user frames transmitted during said interrupting by the interruption unit;
a response maintenance frame transmission processing unit performing a transmission processing on a response to the maintenance frames when the transmission processing of the user frames is interrupted by the interruption unit;
a resume unit resuming a transmission processing of the subsequent user frames which were interrupted by the interruption unit when the transmission processing is performed on the response maintenance frames by the response maintenance frame transmission processing unit; and
a resume transmission processing control unit adding combination information and header information stored in the header information storage unit used for combining pre-interruption user frames to the user frames which are transmitted when transmission processing is resumed by the resume unit.

2. A transmission apparatus comprising:
a transmission-reception unit transmitting and receiving, user frames generated by a user apparatus and maintenance frames which are used for maintenance of a network, to/from another transmission apparatus in the network;
a header information storage unit storing header information of user frames that are currently being transmitted to the other transmission apparatus;
a maintenance frame detection unit detecting whether a maintenance frame is received during a transmission processing of user frames to the other transmission apparatus;
an interruption unit splitting the user frames during the transmission processing and interrupting the transmission processing of the user frames when said detecting indicates that the maintenance frame is received during the transmission processing of the user frames;
a transmission processing control unit adding to subsequent user frames combination information which is used for combining the user frames transmitted during the interrupting by the interruption unit;
a response maintenance frame transmission processing unit performing a transmission processing on a response to the maintenance frames when the transmission processing of the user frames is interrupted by the interruption unit;
a resume unit resuming a transmission processing of the subsequent user frames which were interrupted when the transmission processing is performed on the response to the maintenance frames by the response maintenance frame transmission processing unit;
a resume transmission processing control unit adding combination information and header information stored in the header information storage unit used for combining pre-interruption user frames to the user frames which are transmitted when transmission processing is resumed by the resume unit; and
a combining unit which combines the user frames based on the combination information when split user frames are received by the other transmission apparatus.

3. A method of processing maintenance frames for measuring a round-trip delay time when a transmission apparatus on a measuring side, by which maintenance frames used for maintaining a network were transmitted, receives response maintenance frames returned by another transmission apparatus, comprising:
the other transmission apparatus executing operations including:
retaining header information of user frames for which a transmission processing is currently being performed;
detecting whether the maintenance frames are received during the transmission processing of the user frames;
splitting the user frames for which the transmission processing is currently being performed and interrupting the transmission processing of the user frames when said detecting indicates that said maintenance frames are received during the transmission processing of the user frames;
adding combination information for joining user frames transmitted during said interrupting with subsequent user frames;
transmitting response maintenance frames, which are responses to the maintenance frames when the transmission processing of the user frames is interrupted;
resuming the transmission processing of the subsequent user frames which was interrupted when the transmission processing is performed on the response maintenance frames;
adding combination information and the header information which is used for joining the user frames transmitted during the resuming of transmission processing to pre-interruption user frames, and
wherein the transmission apparatus on the measuring side combines the user frames based on the combination information when the user frames which are split by the other transmission apparatus are received.

4. A storage media, readable by a computer, on which is recorded a transmission program causing the computer to execute operations including transmitting and receiving to/from another transmission apparatus with which a network is formed, user frames generated by a user apparatus and maintenance frames used in maintaining the network, said operations comprising:
retaining header information of the user frames which are currently being processed for transmission to the other transmission apparatus;
detecting whether the maintenance frames were received during a transmission processing of the user frames to the other transmission apparatus;
splitting the user frames for which the transmission processing is currently being performed and interrupting transmission processing of the user frames when detecting that a maintenance frame is received during the transmission processing of the user frames, adding combination information for combining user frames which were transmitted during said interrupting with subsequent user frames;
performing a transmission processing on response maintenance frames, which are responses to the maintenance frames, when the transmission processing of user frames is interrupted;
resuming a transmission processing of the subsequent user frames interrupted by the interrupting when the transmission processing is performed on the response maintenance frames; and
adding the combination information and header information retained for combining the user frames transmitted during said resuming with pre-interruption user frames.

5. A method of processing maintenance frames, comprising:
interrupting transmission of user frames when detecting receipt of maintenance frames during a transmission of said user frames;
splitting said user frames in portions based on states of transmissions thereof and transmitting a response to said maintenance frames; and
transmitting a remaining of said user frames subsequent to the interrupting and combining the user frames split using combination information added thereto at said splitting, where a round-trip delay is calculated using a time of transmission of said maintenance frames and receipt of said response to the maintenance frames.
